(19) United States
(12) Patent Application Publication
(10) Pub. No.: US 2004/0081104 A1
(43) Pub. Date: Apr. 29, 2004

(54) Method and system for network switch configuration

(76) Inventors: Weimin Pan, Austin, TX (US); Yinglin Yang, Round Rock, TX (US)

Correspondence Address: HAMILTON & TERRILE, LLP, P.O. BOX 203518, AUSTIN, TX, 78720, US

(21) Appl. No.: 10/282,627

(22) Filed: Oct. 29, 2002

(51) Int. Cl. H04L 12/28

(52) U.S. Cl. 370/254

(57) ABSTRACT

Network switches of an information handling system are automatically configured by a PXE agent associated with each network switch, such as a PXE agent embedded in firmware of each network switch. The PXE agent automatically requests a configuration image during boot of the network switch and re-configures the network switch with the configuration image. For instance, the PXE agent requests configuration service from a PXE server, which directs a TFTP server to download the configuration image to the network switch. In one embodiment, a blade server has plural server blades supported in plural chassis with each chassis having one or more switches. Each switch has a PXE agent so that the switches of the blade server are automatically configured with the same configuration image. Alternatively, selected configuration factors, such as a static IP address, are individually configured by reference to a unique identification, such as a universal unique identifier.

### BACKGROUND OF THE INVENTION

1. Field of the Invention

The present invention relates in general to the field of network information handling systems, and more particularly to a method and system for network switch configuration.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One type of information handling system that provides flexibility in managing network information is a blade server having plural server blades. A blade server is scalable to meet processing requirements for network information by increasing the number server blades as network processing requirements increase. The server blades are supported in a server chassis and typically interfaced with each other and a network by two managed Ethernet switches per chassis. The deployment of blade servers may include a large number of chassis with each chassis having a number of server blades to process information. For instance, a deployment of blade servers may include 25 chassis in one or more racks with each chassis having several blades interfaced by two Ethernet switches so that the blade server has a total of 50 Ethernet switches capable of interfacing with a network.

One difficulty with switches in a blade server chassis is that the switches are typically configured with identical or substantially similar configurations. The switches are typically configured during manufacture to have a default configuration, however, end users generally customize the configuration of switches after delivery from the manufacturer with desired configuration factors such as a static or dynamic IP address, gateway, VLAN, trunk, port speed and other settings. Generally, in order to modify a switch configuration, an end user interfaces with a serial management port of the switch to change the configuration factor settings or to manually download pre-defined configuration settings as a file, such as from a TFTP server. Large amount of blade servers with many managed Ethernet switches are time consuming to configure in this manner.

### SUMMARY OF THE INVENTION

Therefore a need has arisen for a method and system which automates the setting of network switch configurations for network switches of an information handling system.

In accordance with the present invention, a method and system are provided which substantially reduce the disadvantages and problems associated with previous methods and systems for setting network switch configurations of an information handling system. A configuration agent associated with each network switch automates the network switches to search for and load a configuration image or file so that all network switches of an information handling system are automatically downloaded the same or a substantially similar configuration.

More specifically, a Pre-boot Execute Environment (“PXE”) agent is embedded in the firmware of the managed Ethernet network switches of a blade server. During a boot time, the PXE agent requests a configuration image for its associated network switch from a PXE server, automatically re-configures the associated network switch and re-boots the network switch to operate with the new configuration. For instance, the PXE agent contacts a DHCP server associated with the PXE server and is instructed to obtain boot service from a boot server and configuration service from a configuration server. The network switch PXE agent downloads a predefined configuration image from the configuration server to the associated network switch. One or more configuration factors may be individually set by altering the configuration file path with pre-defined unique identifiers, such as a Universal Unique Identifier (UUID), to avoid a desired pre-configuration step, such as avoid the setting of a dynamic IP address in favor of a static IP address. A PXE agent associated with each network switch of a blade server allows automated configuration of the network switches to have the same or substantially the same configuration. Once the network switches are configured, the PXE agents may be disabled to preclude subsequent requests for the configuration service and enabled when a change to the configurations of the network switches is desired.

The present invention provides a number of important technical advantages. One example of an important technical advantage is that the configurations of the network switches of a blade server are automatically set. Automatic loading of the configurations reduces the time used in setting up a blade server by allowing network switches to download the desired configuration for each network switch during boot, thus reducing or eliminating manual loading of configuration factors. The downloading of a defined configuration also reduces the risk that erroneous configuration factors will be entered by manual setting of configuration factors. For selected configuration factors that vary from switch to switch, such as a static IP address, unique identifiers allow automated loading of independent configuration factor information.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for configuring network switches associated with a blade server information handling system; and

FIG. 2 depicts a flow diagram of a process for configuring network switches.

### DETAILED DESCRIPTION

Automated remote replication of a defined configuration to a number of components of an information handling system is accomplished with a PXE agent associated with the components. For instance, information handling systems that have a relatively large number of network switches, such as blade servers, are able to load the same or substantially similar configurations by interfacing PXE agents associated with each network switch with a configuration service having an image of the configuration. For purposes of this application, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

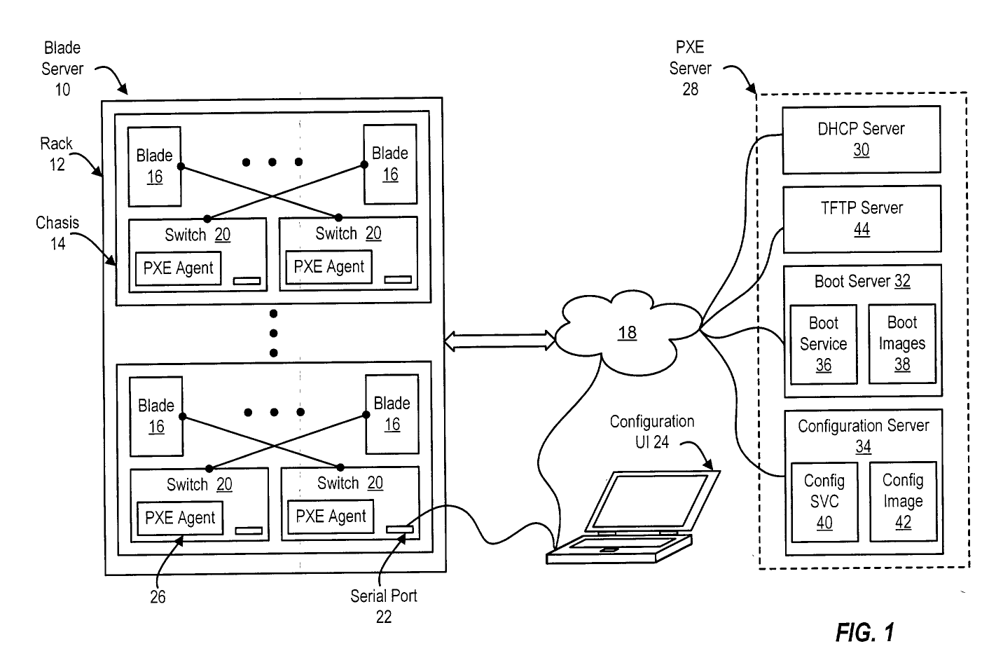

Referring now to FIG. 1, a block diagram depicts a system operable to load a configuration image to plural network switches of a blade server. Blade server 10 has a rack 12 that supports plural chassis 14. Each chassis 14 supports plural server blades 16 to process network information. Server blades 16 interface with each other and a network 18 through one or more network switches 20. Network switches 20 are managed Ethernet switches that route processed network information to and from server blades 16. Dual network switches 20 loaded on each chassis provide redundant switching of network information with each server blade 16 communicating with each other or network 18 through either of the two network switches associated with its chassis 14.

Network switches 20 are integrated with chassis 14 and delivered with a factory default configuration that sets configuration factors such as IP address, gateway, VLAN, trunk and port speed information to default settings. Desired network switch configurations vary depending upon operating conditions, however, are generally the same or substantially the same for the network switches of a given blade server 10. Network switch configurations are manually set through a management interface, such as a serial port 22 and configuration user interface 24 operating on an information handling system. Manually setting the configuration through each network switch management interface presents a time consuming task since blade server 10 may include as many as 25 chassis 14 and 50 network switches 20.

In order to more efficiently set the configurations of network switches 20 for blade server 10, each network switch 20 includes a PXE configuration agent 26. PXE configuration agent 26 is embedded in firmware of each network switch 20 to set configuration factors from a remote configuration image using the protocol of the Preboot Execution Environment Specification. During a boot time, PXE configuration agent 26 communicates over network 18 with a PXE server 28 to download a configuration image to its associated network switch 20. PXE server 28 includes a DHCP server 30, boot server 32 and configuration server 34, and TFTP server 44 deployed in a single information handling system or in separate information handling systems. Upon contact from a PXE configuration agent 26, DHCP server 30 offers a configuration server path. A PXE configuration agent 26 contacts a configuration server 34. DHCP server 30 directs PXE configuration requests to a configuration server 34 and PXE boot request to a boot server 32 for security. Boot server 32 provides boot service 36 based on an identified boot image 38 if requested by an appropriate PXE agent of a network switch 20.

During power up or boot of blade server 10 or a chassis 14, PXE configuration agent 26 requests through DHCP server 30 that configuration server 34 provide configuration service 36. PXE configuration agent 26 of a network switch 20 downloads a selected configuration image 42 from a TFTP server. Each network switch 20 is, in turn, downloaded a copy of configuration image 42 through its respective PXE configuration agent 26 until each network switch has the same or substantially the same configuration. The desired settings for the configuration factors are set through interaction of configuration user interface 24 with a network switch and copied to configuration server 34 through network 18. One or more configuration factors may be independently set for individual network switches or pairs of network switches associated with a chassis 14 based on unique numbers associated with the network switch, such as a universal unique ID (UUID). To individualize configuration factors, such as setting static IP addresses for each network switch, configuration file path is predefined with a unique identifier to avoid the associated preconfiguration step. Once a network switch has downloaded the desired configuration image, PXE configuration agent 26 re-boots network switch 20 with the new configuration and is then disabled to preclude subsequent calls for configuration service. In the event of subsequent changes to network switch configuration, PXE configuration agent 26 is enable to download a new configuration image 42.

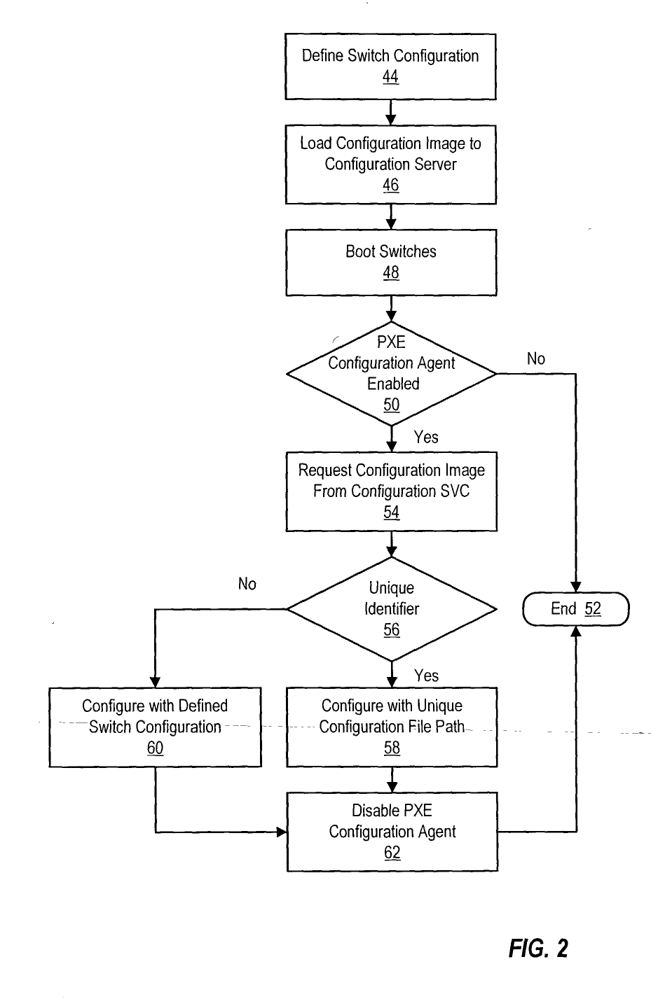

Referring now to FIG. 2, a flow diagram depicts the process for configuring network switches of a blade server. The process begins at step 44 with the definition of a network switch configuration. For instance, configuration graphical user interface 24 interfaces with serial port 22 to configure a network switch 20 with desired configuration factors. At step 46, an image of the configuration of the configured network switch 20 is copied to configuration server 34 through network 18. At step 48, network switches 20 are booted, such as by applying initial power to blade server 10 or by manually initiating a boot. At step 50, a determination is made of whether PXE configuration agent 26 is enabled. For instance, PXE configuration agent 26 is disabled, no contact will be made to configuration server 34 and boot will continue with the current configuration settings. Similarly, if PXE configuration agent 26 lacks a configuration image 42 listing for the network switch 20, if the configuration server 34 is unavailable or if no configuration image 42 is loaded on configuration server 34, then the process ends at step 52 and boot continues with the current configuration.

At step 50 if configuration service is enabled, the process continues to step 54 for a request of the configuration image 42 from configuration server 34. At step 56, a determination is made of whether the network switch 20 requesting the configuration image is associated with a unique identifier. For instance, a configuration that includes a static rather than dynamic IP address will have an associated unique identifier to provide the distinct static IP address instead of the IP address of the configuration image. If at step 56 a unique identifier is determined, the process continues to step 58 for configuration with the unique configuration file path associated with the unique identifier to download the configuration image and the distinct configuration factor. If at step 56 a unique identifier is not determined, the process continues to step 60 to download the defined switch configuration image 42. Once the configuration image is downloaded at step 58 or 60, the process continues to step 62 for the disabling of the configuration service. For instance, PXE configuration agent 26 is disabled to prevent calls to PXE server 28 that would result in repeated reconfiguring of the network switch at each boot. The process then continues to step 52 for boot of the network switch to continue. The process for downloading configuration image 42 may be repeated for each network switch of a blade server until all network switches have the same or substantially similar configurations.

Although the present invention has been described in detail, it should be understood that various changes, substitutions and alterations can be made hereto without departing from the spirit and scope of the invention as defined by the appended claims.

What is claimed is:

1. An information handling system for communicating information with a network, the information handling system comprising:
a rack;
plural chassis supported by the rack;
plural server blades supported by each chassis, each server blade operable to process network information;
plural switches supported by each chassis, each switch interfaced with the server blades associated with the chassis and with the network, each switch having a configuration; and
a configuration agent associated with each switch and operable to request a configuration image from the network and to configure its associated switch with the configuration image.

2. The information handling system of claim 1 wherein each switch comprises a managed Ethernet switch.

3. The information handling system of claim 1 wherein the configuration agent comprises a PXE agent.

4. The information handling system of claim 3 wherein the configuration agent is operable to request the configuration image from a PXE server.

5. The information handling system of claim 4 wherein the configuration agent is further operable to accept the configuration image from a TFTP server selected by the configuration server.

6. The information handling system of claim 1 wherein the configuration agent request for a configuration agent comprises a unique identifier for the associated switch, the network providing the configuration agent with a configuration factor based on the unique identifier.

7. The information handling system of claim 6 wherein the configuration factor comprises a static IP address.

8. A method for configuring network switches associated with an information handling system, the method comprising:
defining a network switch configuration;
loading the defined configuration onto a configuration server as a configuration image;
booting the switches;
requesting, during the boot of each switch, a copy of the configuration image from the configuration server; and
automatically reconfiguring each switch with the configuration image.

9. The method of claim 8 wherein defining a network switch configuration further comprises:
interfacing a configuration module with one of the network switches; and
setting the configuration factors of the one network switch to desired settings.

10. The method of claim 8 wherein requesting a copy of the configuration image further comprises:
requesting the copy of the configuration image with a PXE agent.

11. The method of claim 10 further comprising:
responding to the PXE agent request for a configuration image by loading the copy of the configuration image from a TFTP server.

12. The method of claim 8 further comprising:
providing the configuration server with a unique identifier for one or more of the network switches; and
altering one or more configuration factors of the configuration image for the one or more switches.

13. The method of claim 12 wherein the altered configuration factors comprise one or more of the network switch IP address, gateway, VLAN, trunk or port speed.

14. The method of claim 12 wherein the altered configuration factors comprise a static IP address for a network switch.

15. The method of claim 8 wherein automatically reconfiguring each switch further comprises:
re-booting the switch with the defined configuration; and
disabling the switch from requesting a copy of the configuration image at the next boot.

16. The method of claim 8 wherein requesting a copy of the configuration image further comprises requesting the copy from a PXE server.

17. The method of claim 16 wherein requesting a copy of the configuration image further comprises the PXE server commanding a PXE agent to download the configuration image from a TFTP server to the network switch.

18. A system for automatically configuring plural network switches, the network switches associated with an information handling system for handling network information of a network, the system comprising:
a configuration server interfaced with the network switches through the network;
one or more configuration images associated with the configuration server; and
a PXE agent associated with each network switch of the information handling system, the PXE agent operable to automatically request the configuration image through the network and to reconfigure the associated network switch.

19. The system of claim 18 wherein the PXE agent comprises instructions embedded in switch firmware.

20. The system of claim 19 wherein the PXE agent is further operable to reconfigure the switch to disable subsequent downloading of the configuration image.
